(19) United States
(12) Patent Application Publication
(10) Pub. No.: US 2010/0005987 A1
(43) Pub. Date: Jan. 14, 2010

(54) Reversible printing table

(75) Inventor: Gur Shapira, Zoran (IL)

Correspondence Address: ROBERT G. LEV, 4766 MICHIGAN BLVD., YOUNGSTOWN, OH, 44505, US

(73) Assignee: Matan Digital Printers Ltd., Rosh Ha'Ayin (IL)

(21) Appl. No.: 12/316,784

(22) Filed: Dec. 16, 2008

(30) Foreign Application Priority Data
Jul. 9, 2008 (IL) IL 192713

(51) Int. Cl. B41F 21/00

(52) U.S. Cl. 101/407.1

(57) ABSTRACT

A printing table for supporting a substrate opposite a print-head. The printing table comprises a plurality of substrate supports which are selectively presentable towards the print head.

### PRIORITY INFORMATION

The present invention claims priority to Israel Patent Application No. IL 192713 filed Jul. 9, 2008, making reference hereto in its entirety.

### FIELD OF THE INVENTION

The present invention is directed to providing a printer, particularly but not exclusively a wide format inkjet printer, that is capable of high quality printing onto both rigid and flexible substrates.

### BACKGROUND

Wide format inkjet printing is commonly used for printing posters, wall decorations, signs and the like. The medium to be printed, if flexible, is typically provided on a continuous roll and is advanced, roll to roll, past the print head. Sometimes however, particularly when printing onto a stiff material, the material to be printed is provided in sheet form and the printing technique is then known as flat-bed printing. The wider the sheet, the greater the tendency for it to be warped or misaligned whilst being fed past the print head, and a great deal of effort has been expended in keeping the medium taut and flat.

In both printing technologies, advancing systems are required to accurately position the material to be printed with respect to the print head. Even a small deviation from the correct positioning results in noticeable printing defects.

To save space and equipment costs, it is useful for a single machine to be able to operate as both a flat-bed printer and as a roll to roll printer. However, the wider the material to be printed, the more difficult it is to maintain alignment between substrate and print-head. Therefore, providing a single printer that is capable of accurate flat-bed and roll to roll printing, though desirable, is not easily achieved.

WO04037543 to Nur Macroprinters LTD., titled “Advancing System and Method for a Digital Printing Apparatus”, describes a printer apparatus comprising a print head system and an advancing system. The print head includes a print head assembly mounted for movement along at least one horizontal axis with respect to a printing area. The advancing system is configured and operable for enabling the selective locating of the printing area in either one of a first or a second printing plane spaced-apart vertically, thereby selectively exposing the first or second printing plane to the print head assembly for printing. The first and second printing planes are defined by, respectively, a first flat-bed assembly and a second roll-to-roll assembly of the advancing system.

Nur Macroprinter's solution requires moving the print head from one printing plane to another. In each printing mode the print head moves over a relatively wide table in two directions. The two printing modes use different printing tables. Moving from one printing mode to another in this manner is likely to be time consuming. Furthermore, since the print head may be moved with respect to the substrate to be printed in three directions, accurate, repeatable alignment and moving from one printing type to the other is not easy. Because two printing tables are used, both require calibrating to attain planarity in a parallel plane to the movement of the print head, and this planarity is not easily achieved since the printing tables have a tendency to warp.

U.S. Pat. No. 6,296,403 to Scitex Vision describes a dual-mode printer for printing on both flexible and rigid substrates, that includes a table for providing a substantially planar support surface for supporting a substrate thereupon. A flexible-substrate feed system is configured to feed a flexible substrate in a given feed direction across the support surface. The printer has a print head configured for depositing a printing medium on a substrate as part of a printing process. A motion system is configured to generate relative displacement between the print head and the support surface in at least a first direction parallel to the feed direction. This combination of components allows the printer to be used in a flexible-substrate mode in which relative displacement between the substrate and the print head is generated at least in part by the flexible-substrate feed system and in a rigid-substrate mode in which relative displacement between the substrate and the print head is generated exclusively by the motion system. The table used is a wide table suitable for flat-bed printing, which, when used for roll-to-roll printing, is inherently unsuitable as the distance between the rollers is large, and the flexible substrate to be printed is likely to assume a wavy surface which adversely affects the resolution of the printing thereon.

Russian Patent Number RU 2167063 relates to a method of printing wherein the substrate to be printed is fed roll to roll and the table moves as well

WO05074519, to L & P Property Management Company, describes an apparatus and a method of ink jet printing that uses a system for feeding a substrate longitudinally relative to a support area and a system for moving a print head parallel to the direction of the substrate feed. Indexing between transverse scan rows of a print head is carried out initially by the substrate feed system and the actual feed distance is measured using an encoder or other substrate position measurement device. A controller determines the amount of any error that occurs between the actual and the desired feed distances. The controller then sends signals to move the print head to compensate for any error in the feed system feed. Compensating adjustments are then made to the next subsequent substrate indexing step so that the print head tends to move back toward its ‘home’ i.e. zeroed position with its next correction and does not walk away from this home position as a result of cumulative movements. For printers that have bridges that are moveable relative to the machine frame on which the print head is carried, print head motion is achieved by moving the bridge, for example, by actuating a linear servo bridge motion system. For fixed bridge roll-to-roll printers, the print head can be caused to shift longitudinally on the bridge to make the correcting movements. The controller for controlling the amount of error and the need for compensation thereof indicate the problems in obtaining accurate positioning where the bridgehead moves relative to the support area, the support area moves relative to the material to be printed, and the material to be printed is fed as well.

Many of the disadvantages of these previous systems are addressed by the applicant's co-pending patent application, U.S. Ser. No. 11/693,449, which discloses a wide or super wide digital printer comprising a print head box that reciprocates from left to right across a wide or super wide printing table having a length of less than 20 cm that is supported by a fixed support, and a feed roller and a guiding roller that are moveably coupled to the fixed support, wherein the wide or super wide digital printer is alternatively configurable as (a) a roll to roll printer by lowering the feed roller and the guiding roller to a lowered configuration wherein uppermost parts of the feed roller and the guiding roller are below the upper surface of printing table, or (b) as a discontinuous sheet printer by raising the feed roller and the guiding roller to a raised configuration wherein the uppermost parts of the feed roller and the guiding roller are collinear with the upper surface of the printing table.

Nevertheless, when flat-bed printing, onto a wide sheet, it is, preferable to support the section of the substrate on a substantially planar printing table beneath the print-heads. This significantly reduces distortion or warping of the specific section of substrate being actively printed. In contradistinction to flat-bed printing, when printing onto flexible material, in order to provide high resolution printing it is often preferable to pass the substrate below the print head under tension. It is difficult to keep a flexible material which is passed over a planar printing table adequately tensioned by dual mode printers of the prior art. Therefore prior art systems tend to have limited performance in one or other of the printing modes.

There remains a need for dual mode printers capable of high resolution printing onto both flexible and rigid substrates and particularly for wide/super wide dual mode printers and the present invention addresses this need.

### SUMMARY OF THE INVENTION

The present invention is directed to providing cost-effective and space saving wide format printers optimized to cope with a range of substrates.

Specifically, an aspect of the present invention is directed to providing a printing table for supporting a substrate opposite a print head, the printing table comprising a plurality of substrate supports selectively presentable towards the print head.

Optionally, the printing table is adjustable between a first configuration and a second configuration such that when in the first configuration a first substrate support is presented towards said print head and when in the first configuration a second substrate support is presented towards said print head.

In preferred embodiments, the substrate supports are mounted upon a rotatable beam such that when the first substrate support is rotated towards the print head, the printing table is configured in a first printing mode and when said second substrate support is rotated towards said print head said printing table is configured in a second printing mode.

Typically, the rotatable beam has a cross section selected from the list comprising: H-shapes, T-shapes, C shapes, L-shapes, U-shapes, quadrilaterals and triangles, thereby providing substrate supports selected from the list of knife edges, vacuum chuck type surfaces, flat surfaces, and open trays.

Preferably, at least one substrate support comprises a U-shaped drip tray. The U-shaped drip tray is generally suitable for supporting open media such as meshes, flag fabric, open-weave and highly porous materials during printing thereonto.

Typically, the at least one substrate support comprises a generally planar surface.

Preferred embodiments are suitable for supporting either rigid or discontinuous laminar substrate during printing thereonto.

Optionally, a plane surface may further comprise a grip for securing the substrate.

Such a grip may comprise a plurality of holes through the generally plane surface, the holes being in fluid communication with a low pressure pipe, thereby providing a vacuum chuck.

In some embodiments, at least one substrate support comprises a knife edge over which a flexible substrate may be stretched.

The printing table is essentially a component of a printer that further comprises rollers, wherein a first substrate support is configured to be used in combination with a feed roller and a guiding roller for roll-to-roll printing.

Optionally, the feed roller and the guiding roller are alignable with an upper surface of a second substrate support such that a rigid and/or discontinuous laminar substrate may be supported by the feed roller, the guiding roller and the printing table.

The printing table is typically incorporated within an ink-jet printer.

Most typically, the ink-jet printer is a wide or super-wide digital printer having an effective printing width of at least 2.5 m.

In preferred embodiments, the digital printer is a wide or super-wide digital printer having an effective printing width of at least 3 m and perhaps up to 10 m or more.

Typically, at least one of the substrate supports has a length of between 10 and 20 cm.

Usefully, adjusting the printing table from a first configuration to a second configuration takes less than five minutes and possibly, less than one minute.

The term substrate as used herein refers to any medium to be printed upon, including paper, fabric, card, cardboard, boards of various types, whether supplied as roll-stock or in sheet form.

The term mesh, implies a substrate having large pores. In consequence of the pores, when printed, inks tend to pass through to the other side.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice.

In the accompanying drawings:

FIG. 1a is a schematic representation of a digital inkjet printer incorporating a reversible U-shaped printing table according to a first embodiment of the current invention with the printing table shown in a knife-edge configuration as particularly appropriate for roll-to-roll printing;

FIG. 1b is a schematic representation of the reversible printing table of FIG. 1a configured in a flat configuration that is particularly appropriate for flat-bed printing;

FIG. 2 is a schematic representation of a rotatable printing table with an L-shaped cross-section according to a second embodiment of the invention;

FIG. 3 is a schematic representation of a rotatable printing table with a T-shaped cross-section according to a third embodiment of the invention;

FIG. 4 is a schematic representation of a rotatable printing table with a triangular cross-section according to a fourth embodiment of the invention;

FIG. 5a is a schematic representation of a rotatable printing table according to a fifth embodiment of the invention as configured to print onto a porous substrate, and

FIG. 5b is a schematic representation of the rotatable printing table of FIG. 5a, this time configured to print onto a non-porous substrate.

### DESCRIPTION OF THE PREFERRED EMBODIMENTS

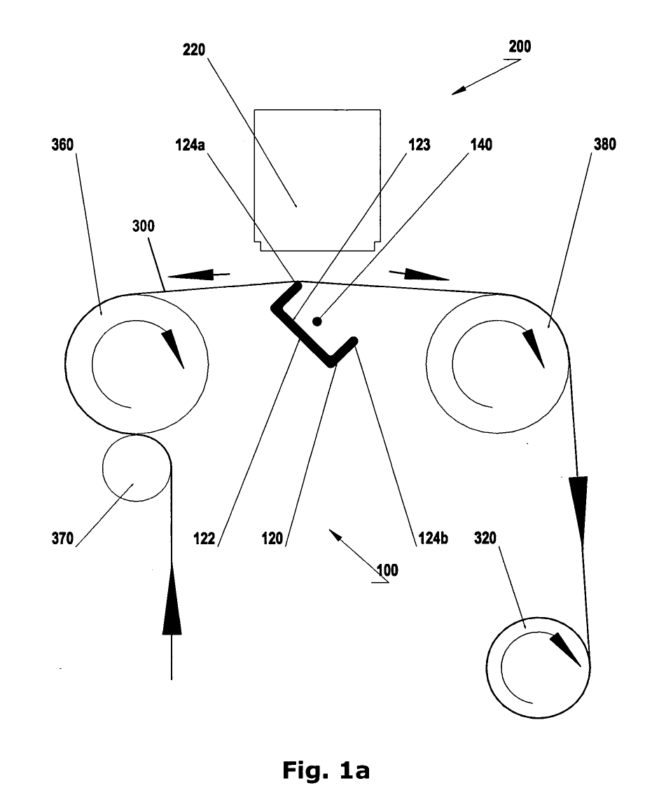

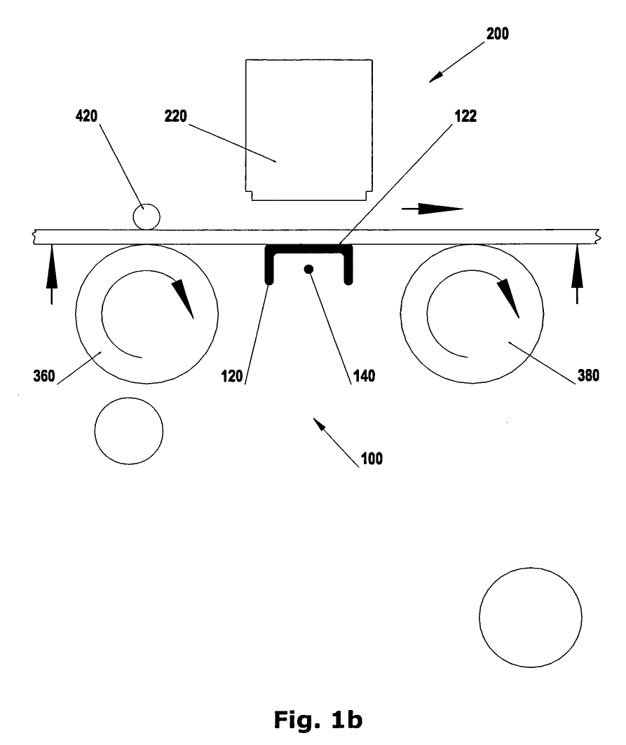

Reference is now made to FIGS. 1a and 1b showing a reversible printing table 100 according to a first embodiment of the invention incorporated into a digital inkjet printer 200 that can print onto material fed by two separate feed modes: either onto a continuous flexible sheet material fed by a roll to roll system, or onto discontinuous sheets such as previously printed on flat-bed printers.

In order to achieve high resolution printing onto a flexible substrate, such as fabric or paper for example, it may be desirable to stretch the flexible substrate over a knife-edge opposite the print head 220. The section of the substrate being printed upon is kept tensioned thereby, making it stiffer and less prone to distortion. Moreover, flexible material under tension undergoes strain and thus a larger area of material is presented below the print head, thereby enabling printing with a higher resolution onto the taut material, and resulting in a higher resolution when tension is released.

On the other hand rigid substrates, such as cardboard and the like, are preferably supported by a substantially planar printing table so as to reduce distortion or warping of the section of substrate being printed upon.

It is a particular feature of the current invention that the printing table thereof has two substrate supports which may be selectively presented towards the print head. The printing table is therefore configurable in two configurations: (i) a knife-edge configuration for stretching a flexible substrate over a protruding edge and (ii) a flat configuration for supporting rigid and/or discontinuous laminar substrates thereof.

Specifically, according to a first embodiment of the invention, shown in FIGS. 1a and 1b, the printing table consists of a beam 120 having a substantially flat bottomed U-shaped cross section. The U-shaped beam is rotatably coupled about an axle 140. The flat bottom 122 of the U-shaped beam provides a first generally planar substrate support and the tips 124 of the uprights of the U provide generally straight knife-edge substrate supports. The printing table may thus be configured for roll-stock printing, as shown in FIG. 1a, by aligning the generally straight knife-edge 124a towards the print head 220. Alternatively, the printing table may be configured for flat-bed printing, as shown in FIG. 1b, by aligning the generally planar face 122 towards the print head 220.

In the following description, since the direction of travel of the print head is generally referred to as from side to side, and printing as described herein is generally referred to as being wide or super-wide printing, the direction along the roller is referred to as the width and the direction perpendicular to the length of the rollers is referred to hereinbelow as the ‘length’, despite it being appreciated that (contrary to common usage) in these applications the ‘width’ is typically the longer dimension of the medium.

With particular reference to FIG. 1a, the printing table 120 may be adjusted to the configuration particularly appropriate for printing onto roll-stock, bringing a knife-edge substrate support 124a into alignment with the print head 220 by rotating the U-shaped beam 120 about its axle 140 such that the tip 124a of one upright is opposite the print head 220. It is noted that in this configuration, the internal surface 123 of the U-shaped beam serves as a drip tray. Ink passing through the substrate 300 may collect into the drip tray 123 below. This feature is particularly useful when printing onto nets, meshes and the like, such as those used for covering monuments and buildings under renovation, large hanging signs on buildings and the like.

According to certain embodiments of the invention, the flexible substrate 300 may be supplied on one roll (not shown), is stretched over the knife-edge 124a and wound onto a second roll 320. The substrate 300 is typically threaded between a feed roller 360 and a pressure roller 370 and kept pressed onto the feed roller 360 by a pressure roller 370. The feed roller 360 advances the substrate 300 incrementally in small steps between passes of the print heads 220 as their carriage moves from side to side along a track (not shown) over the knife edge 124a of the printing table 100. The substrate 300 is fed over a guide roller 380 and around a tension roller which keeps the substrate 300 flat. It will be noted that the feed roller 360 and guiding roller 380 are preferably positioned slightly below the straight edge 124a. This enables the flexible substrate 300 to be stretched over the straight edge 124a and thereby kept taut and flat over the printing table 100; it being appreciated that unless the substrate 300 is kept flat during printing, the resolution and accuracy of the printing may be adversely affected.

Referring now to FIG. 1b, the printing table 100 may alternatively be adjusted into its flat-bed configuration by rotating the U-shaped beam 120 such that the generally planar substrate support 122, formed by the flat bottom of the U, is presented to the print head 220. The generally planar face 122A is particularly useful for supporting rigid and/or discontinuous laminar substrates 400. In preferred embodiments of the invention, the printer 220 may be further adjusted by raising the feed roller 360 and the guiding roller 380 so that they are co-planar with the planar face 122 of the printing table 100. The feed roller 360 and the guiding roller 380, once raised, may then provide additional support for the rigid substrate 400. Guide wheels 420 can be lowered to apply a pressure onto the upper surface of the laminar substrate 400 to keep it pressed onto the feed roller 360.

It is a particular feature of preferred embodiments of the invention that, because of the additional support provided by the rollers, the printing table itself need not be long. For wide/super wide digital printing applications, where space is at a premium, in some embodiments of the invention the printing table may be no more than 15% of the effective printing width.

Preferably, adjustment of the printing table 100 from its knife-edged configuration for the printing of flexible substrates 300 to its flat configuration for the printing of rigid substrates 400 by rotation thereof around its axis 140 is a simple and quick procedure which may be completed in under five minutes. To this end, the adjustment may be automated and driven by a switch controlled driver, in which case such adjustment may be completed in less than one minute.

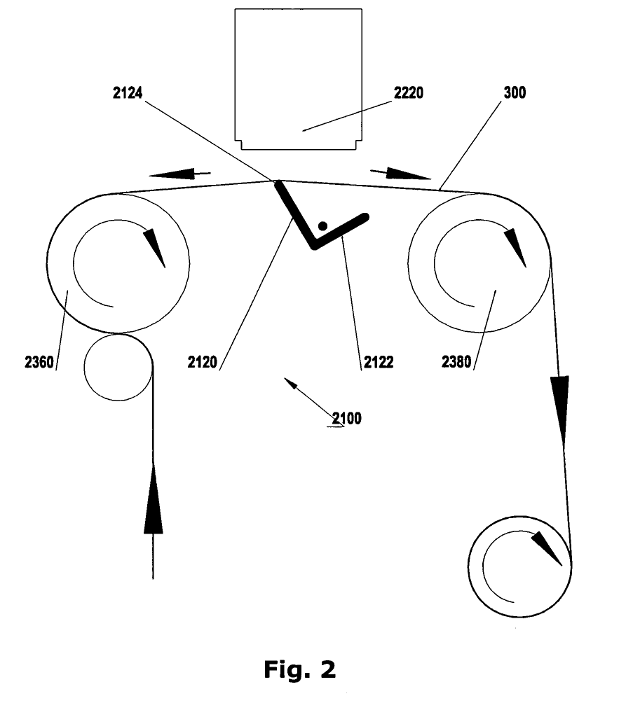

It is noted that although a U-shaped printing table 100 is described herein other embodiments may use alternative cross-sections. For example FIG. 2 shows a rotatable beam 2120 of a printing table 2100 having an L-shaped cross section which may be an extrusion. In order to adopt the knife-edge configuration with the L-beam 2120 of the second embodiment, the tip 2124 of the L is directed towards the print head 2220. A flexible substrate 300 may then be stretched over the edge 2124 formed by the extended tip of the L-beam 2120 and the print head 2220 configured to move along a track from side to side above the printing table 2100. Alternatively, the L-beam 2120 of the second embodiment may be rotated such that the flat base 2122 of the L is brought into alignment opposite the print head 2220. A rigid and/or discontinuous laminar substrate may then be supported by the flat base 2122 of the L-beam 2120 providing a printing table 2100, as well as by the raised feed roller 2360 and guiding roller 2380, or print tables. This prevents warping or distortion of the rigid substrate.

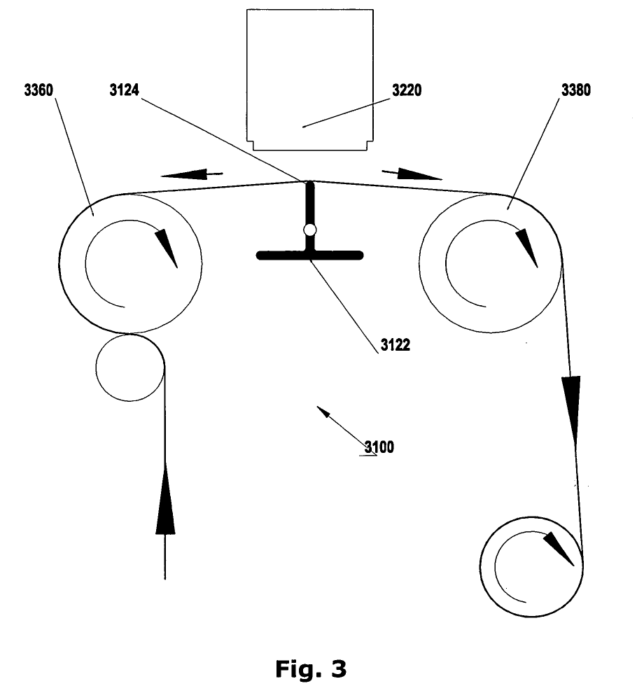

According to a third embodiment of the invention, as shown in FIG. 3, a rotatable beam 3120 of the printing table 3100 has a T-shaped cross section. In order to adopt the knife-edge configuration with the T-beam of the second embodiment the foot 3124 of the T is turned to face the print head 3220. In order to adopt the flat-bed configuration, the T-beam 3120 is rotated such that the flat top 3122 of the T is brought into alignment opposite the print head 3220.

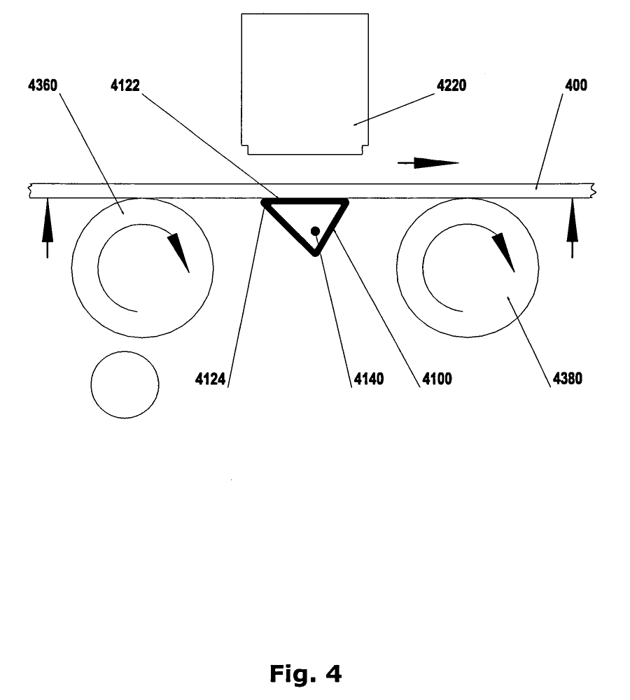

FIG. 4 shows the printing table 4100 according to yet a fourth embodiment of the invention. Here the rotatable printing table 4100 is provided with a triangular cross section and mounted upon an axle 4140 such that it may be rotated to present a side 4122 of the triangle or an acute vertex 4124 of the triangle towards the print head 4220. If the vertex 4124 is sufficiently acute, for example less than 45 degrees, the edge subtended along the triangular beam 4120 at the vertex of its cross-section forms a knife-edge. A flexible substrate may then be stretched between two rollers 4360, 4380 over the knife-edge. Alternatively, with a side 4122 of the triangular cross section 4120 presented towards the print head 4220, a flat printing table 4100 is provided more appropriate for rigid substrates 400.

It will be appreciated that triangular printing tables 4100 actually provide the possibility of presenting three faces to the print head and three vertices. Some or all the faces may be different, or similar. They may simply provide backup in case of damage, for example.

In preferred embodiments, the feed roller 360, as shown in FIGS. 1a and 1b, is usually rubber coated to provide a high friction surface. The rollers 360, 380 are rigid by their construction and resist bending. The table 100 may then be less rigid than the rollers 360, 380. It will be noted that for wide and super wide printing, the width of the table may be several meters. Preferably the table 100 is supported periodically by adjustable supports and the absolute height of the table 100 at each support point may be adjusted to ensure planarity. The intrinsically stiff rollers 360, 380 may be used for this purpose.

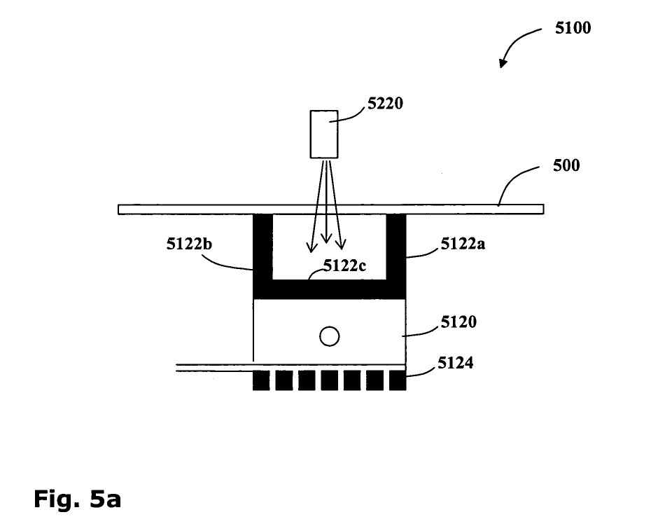

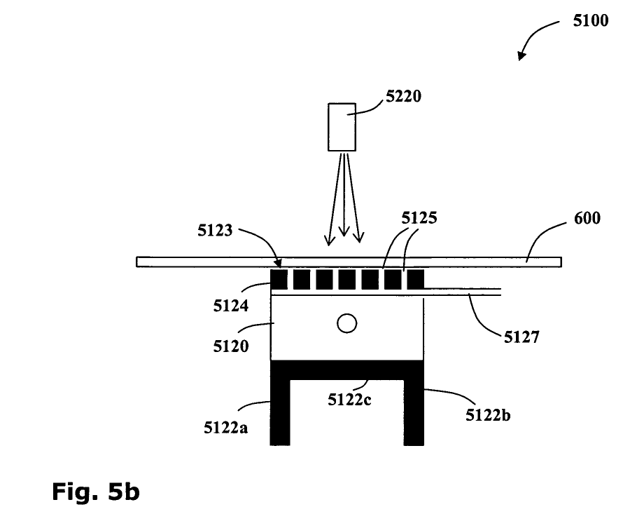

FIGS. 5a and 5b show a schematic representation of a rotatable printing table 5100 according to a fifth embodiment of the invention. The printing table 5100 has two substrate supports 5122, 5124 mounted upon a rotatable beam 5120 and which may be presented to a print head 5220 selectively to provide two printing modes. The first printing mode, shown in FIG. 5a, is particularly appropriate for printing onto porous media 500, and in particular, for printing onto meshes, where substantial amounts of ink pass through the media. The first printing mode, is also useful for printing onto flags, where both sides of the media are viewed. The second printing mode, shown in FIG. 5b, is generally more appropriate printing onto non-porous substrates 600.

Referring now specifically to FIG. 5a, the printing table 5100 is shown, configured to print onto porous substrates 500, particularly mesh, but also webbing, netting, woven fabric or the like. The support beam 5120 is configured such that a U-shaped substrate support 5122 is presented to the print head 5220. In this configuration a porous substrate 500 may be supported by the two tips 5122a, 5122b of the U-shaped substrate support 5122. When the print head 5220 prints onto the porous substrate 500, ink penetrating through the substrate is collected in a drip tray 5122c formed by the inner surface of the U-shaped substrate 5122.

In FIG. 5b, the printing table 5100 is shown configured to print onto non-porous substrates 600. The support beam 5120 has been rotated such that a generally flat substrate support 5124 is presented to the print head 5220. Inlets 5125 through the surface 5123 of the generally flat substrate support 5124 lead to a low pressure air pipe 5127 running through the beam 5120.

The non-porous substrate 600, supported by the generally flat substrate support 5124, is gripped to the surface 5123 of the substrate support 5124 by the sucking effect produced by the pressure difference between the ambient air and the low pressure air within the pipe. Thus the flat substrate support 5124 is essentially a vacuum print table. This helps keep substrate 600 flat and wrinkle free, and minimizes undesired movement of the substrate 600 during printing, which increases the accuracy and resolution of the printing.

Super wide printers are typically 3 meters wide or more, and may be over 10 meters wide. Rigidity and planarity of the substrate is important for high resolution printing. In contradistinction to the prior art, according to preferred embodiments of the invention, the digital printer uses the feed roller for advancing discontinuous laminar substrates as well as when printing roll to roll. As a result long printing tables are not necessary and a short printing table perhaps around 10 cm and not more than 20 cm may be used. One consequence of this is that the length of the machine is typically well under a meter, nevertheless accurate forwarding of large substrates to be printed is allowed.

Thus persons skilled in the art will appreciate that the present invention is not limited to what has been particularly shown and described hereinabove. Rather the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

I claim:

1. A printing table for supporting a substrate opposite a print-head, said printing table comprising a plurality of substrate supports selectively presentable towards said print head.

2. The printing table of claim 1 being adjustable between a first configuration and a second configuration such that when in the first configuration a first substrate support is presented towards said print head and when in the first configuration a second substrate support is presented towards said print head.

3. The printing table of claim 2 said substrate supports being mounted upon a rotatable beam such that when said first substrate support is rotated towards said print head said printing table is configured in a first printing mode and when said second substrate support is rotated towards said print head said printing table is configured in a second printing mode.

4. The printing table of claim 3 said rotatable beam having a cross section selected from the list comprising: H-shapes, T-shapes, C shapes, L-shapes, U-shapes, quadrilaterals and triangles, thereby providing substrate supports selected from the list of knife edges, vacuum chuck type surfaces, flat surfaces, and open trays.

5. The printing table of claim 1 wherein at least one substrate support comprises a U-shaped drip tray.

6. The printing table of claim 5, the U-shaped drip tray being suitable for supporting open media such as meshes, flag fabric, open-weave and highly porous materials during printing thereonto.

7. The printing table of claim 1 wherein at least one substrate support comprises a generally planar surface.

8. The printing table of claim 1 being suitable for supporting a rigid and/or discontinuous laminar substrate during printing thereonto.

9. The printing table of claim 7 wherein said generally plane surface further comprises a grip for securing the substrate.

10. The printing table of claim 9, said grip comprising a plurality of holes through said generally plane surface, said holes in fluid communication with a low pressure pipe.

11. The printing table of claim 1 wherein at least one substrate support comprises a knife edge over which a flexible substrate may be stretched.

12. The printing table of claim 1 being a component of a printer, said printer further comprising rollers, wherein a first substrate support is configured to be used in combination with a feed roller and a guiding roller for roll-to-roll printing.

13. The printing table of claim 12 wherein said feed roller and said guiding roller are alignable with an upper surface of a second substrate support such that a rigid and/or discontinuous laminar substrate may be supported by said feed roller, said guiding roller and said printing table.

14. The printing table of claim 1 being incorporated into an ink-jet printer.

15. The printing table of claim 14 wherein said digital printer is a wide or super-wide digital printer having an effective printing width of at least 2.5 m.

16. The printing table of claim 15 wherein said digital printer is a wide or super-wide digital printer having an effective printing width of at least 3 m.

17. The printing table of claim 15 wherein the digital printer is a wide or super-wide digital printer having an effective printing width of up to 10 m.

18. The printing table of claim 1 wherein at least one of said substrate supports has having a length of between 10 and 20 cm.

19. The printing table of claim 1 wherein adjusting said printing table from a first configuration to a second configuration takes less than five minutes.

20. The printing table of claim 1 wherein adjusting said printing table from a first configuration to a second configuration is actuated with a switch and takes less than one minute.
